(19) United States
(12) Patent Application Publication
(10) Pub. No.: US 2026/0277785 A1
(43) Pub. Date: Sep. 17, 2026

(54) COMPUTER-READABLE RECORDING MEDIUM HAVING STORED THEREIN INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Sayaka Iida, Kawasaki (JP)

(73) Assignee: Fujitsu Limited, Kawasaki-shi (JP)

(21) Appl. No.: 19/558,182

(22) Filed: Mar. 5, 2026

(30) Foreign Application Priority Data
Mar. 14, 2025 (JP) 2025-041250

(51) Int. Cl. G06F 12/02

(52) U.S. Cl. CPC G06F 12/0215

(57) ABSTRACT

A non-transitory computer-readable recording medium having stored therein an information processing program that causes a computer having a computation resource to execute a process including: comparing a free space of a memory included in the computation resource with a data amount of model data of a machine learning model; prefetching the entire model data into the memory when the data amount is equal to or less than the free space; and when the data amount is greater than the free space, generating a plurality of pieces of partial model data by dividing the model data in units of layers constituting the machine learning model, and prefetching one or more pieces of the plurality of partial model data corresponding to the free space among the plurality of pieces of partial model data.

### CROSS-REFERENCE TO RELATED APPLICATION

This application is based upon and claims the benefit of priority of the prior Japanese Patent application No. 2025-041250, filed on Mar. 14, 2025, the entire contents of which are incorporated herein by reference.

### FIELD

The present embodiment relates to a computer-readable recording medium having stored therein an information processing program, an information processing apparatus, and an information processing method.

### BACKGROUND

It is known that processing performance is improved by using acceleration of a processing speed by an accelerator device such as a graphics processing unit (GPU) for execution of a deep learning application (hereinafter, referred to as a deep learning application) (for example, Patent Document 1).

In addition, with rapid development of artificial intelligence (AI) in recent years, a price of a GPU has increased and supply shortage has occurred. Due to the limited number of available GPUs, efficient utilization of GPUs is desired.

For example, related arts are disclosed in Japanese National Publication of International Patent Application No. 2022-515302 (Patent Document 1), US Patent Application Publication No. 2020/0302304 (Patent Document 2), US Patent No. 11797280 (Patent Document 3), International Publication Pamphlet No. WO 2021/210123 (Patent Document 4), and Japanese National Publication of International Patent Application No. 2024-535966 (Patent Document 5).

### SUMMARY

According to an aspect of the embodiments, a non-transitory computer-readable recording medium having stored therein an information processing program that causes a computer having a computation resource to execute a process including: comparing a free space of a memory included in the computation resource with a data amount of model data of a machine learning model; prefetching the entire model data into the memory when the data amount is equal to or less than the free space; and when the data amount is greater than the free space, generating a plurality of pieces of partial model data by dividing the model data in units of layers constituting the machine learning model, and prefetching one or more pieces of the plurality of partial model data corresponding to the free space among the plurality of pieces of partial model data.

The object and advantages of the invention will be realized and attained by means of the elements and combinations particularly pointed out in the claims.

It is to be understood that both the foregoing general description and the following detailed description are exemplary and explanatory and are not description are exemplary and explanatory and are not restrictive of the invention.

### BRIEF DESCRIPTION OF DRAWINGS

FIG. 1 is a diagram schematically illustrating a configuration of an information processing system according to an embodiment;

FIG. 2 is a block diagram illustrating a hardware configuration example of a computer that realizes functions of the information processing system according to an embodiment;

FIG. 3 is a diagram for describing model division processing for model prefetch in the information processing system according to an embodiment;

FIG. 4 is a diagram illustrating data transfer in the information processing system according to an embodiment;

FIG. 5 is a flowchart for describing processing at the time of execution of a job by a user process of the information processing system according to an embodiment;

FIG. 6 is a flowchart for describing processing of a scheduler of the information processing system according to an embodiment; and

FIG. 7 is a diagram illustrating a method of loading model data in the information processing system according to an embodiment in comparison with a conventional method.

### DESCRIPTION OF EMBODIMENTS

In order to use a GPU, data that is needed for execution needs to be moved to a memory (GPU memory) mounted on the GPU. Therefore, in processing using a machine learning model, it is needed to move model data to the GPU memory.

However, processing for data transfer to the GPU memory takes time. In particular, since a large-scale model such as a large language model (LLM) has a large size, a transfer time for transferring model data to the GPU memory may be a bottleneck in inference execution or the like using such a large-scale model.

Hereinafter, embodiments according to the present information processing program, information processing apparatus, and information processing method will be described with reference to the drawings. However, the embodiments described below are merely examples, and there is no intention to exclude the application of various modified examples and techniques that are not explicitly described in the embodiments. That is, the present embodiment can be variously modified and implemented without departing from the gist thereof. In addition, each drawing is not intended to include only the components illustrated in the drawing, but may include other functions and the like.

### A. Configuration

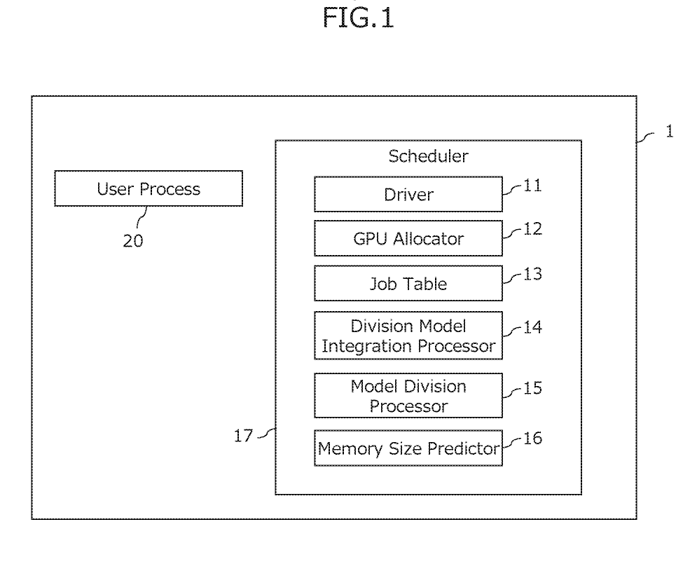

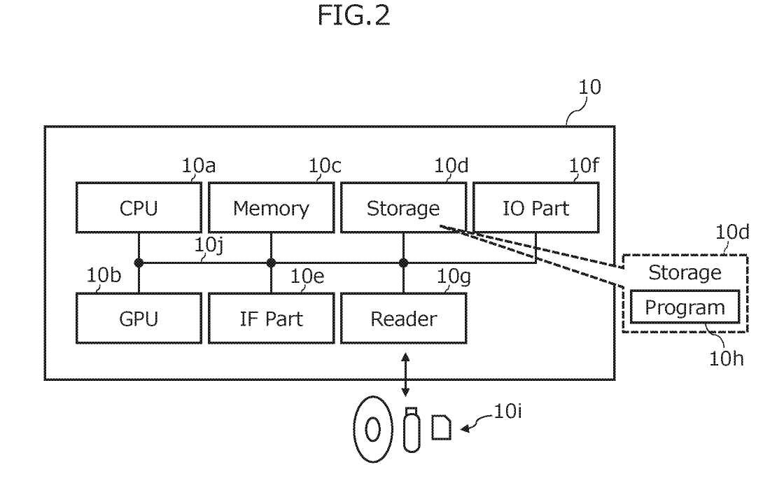

FIG. 1 is a diagram schematically illustrating a configuration of an information processing system 1 according to an embodiment, and FIG. 2 is a block diagram illustrating a hardware (HW) configuration example of a computer 10 that realizes functions of the information processing system 1 according to an embodiment.

### A-1. Hardware Configuration Example

In a case where a plurality of computers are used as HW resources that realize the functions of the information processing system 1, each computer may have the HW configuration illustrated in FIG. 2.

As illustrated in FIG. 2, the computer 10 is an information processing apparatus, and may illustratively include, as an HW configuration, one or more (one in the example illustrated in FIG. 2) CPUs 10a, one or more (one in the example illustrated in FIG. 2) GPUs 10b, a memory 10c, a storage 10d, an interface (IF) part 10e, an input/output (IO) part 10f, and a reader 10g.

The CPU 10a is an example of an arithmetic processing device that performs various controls and computations, and is a controller that executes various types of processing. The CPU 10a may be connected to each block such that they can communicate in the computer 10 via a bus 10j. The bus 10j may be a peripheral component interconnect-express (PCIe) bus. Note that the CPU 10a may be a multiprocessor including a plurality of processors, may be a multi-core processor including a plurality of processor cores, or may have a configuration including a plurality of multi-core processors. The CPU 10a is an example of a computation resource.

The GPU 10b may be, for example, an accelerator such as a general purpose computing on graphics processing unit (GPGPU). In addition, the GPU 10b may be used to perform screen display control on an output device such as a monitor in the IO part 10f. The GPU 10b may have a configuration as an accelerator that executes machine learning processing and inference processing using a machine learning model. Regarding the machine learning processing and the inference processing, the GPU 10b may be said to have higher processing performance than the CPU 10a. GPU 10b is an example of a computation resource. In addition, a video random access memory (VRAM) (not illustrated) is mounted in the GPU 10b. The VRAM of the GPU 10b may be referred to as a GPU memory. The GPU memory is an example of a memory included in the GPU 10b (computation resource).

The memory 10c is an example of HW that stores information such as various types of data and programs. Examples of the memory 10c include one or both of a volatile memory such as a dynamic random access memory (DRAM) and a nonvolatile memory such as a persistent memory (PM). The memory 10c is an example of a first memory used by the CPU 10a. The memory 10c may be referred to as a system memory or a CPU memory.

The storage 10d is an example of HW that stores information such as various types of data and programs. Examples of the storage 10d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), a read only memory (ROM), and the like.

The storage 10d may store a program 10h (user program or information processing program) that realizes all or some of various functions of the computer 10.

For example, the CPU 10a of the information processing system 1 develops the program 10h (information processing program) stored in the storage 10d in the memory 10c and executes the program, thereby realizing a function as a scheduler 17 which will be described later. In addition, the program 10h may include a user program. The CPU 10a realizes a function as a user process 20 which will be described later by executing the user program.

The IF part 10e is an example of a communication IF that controls connection and communication between the computer 10 and another computer. For example, the IF part 10e may include an adapter conforming to a local area network (LAN) such as Ethernet^{®}, optical communication such as a fibre channel (FC), or the like. The adapter may support one or both of wireless and wired communication systems. Note that the program 10h may be downloaded from a network to the computer 10 via the communication IF and stored in the storage 10d.

The IO part 10f may include one or both of an input device and an output device. Examples of the input device include a keyboard, a mouse, a touch panel, and the like. Examples of the output device include a monitor, a projector, a printer, and the like. In addition, the IO part 10f may include a touch panel or the like in which an input device and an output device are integrated. The output device may be connected to the GPU 10b. The IO part 10f may be an input device or an output device of another information processing apparatus remotely connected to the computer 10 by secure shell (SSH) or the like.

The reader 10g is an example of a reader that reads information, such as data and programs, recorded on a recording medium 10i. The reader 10g may include a connection terminal or device to which the recording medium 10i can be connected or inserted. Examples of the reader 10g include an adapter conforming to a universal serial bus (USB) or the like, a drive device that accesses a recording disk, a card reader that accesses a flash memory such as an SD card, and the like. Note that the program 10h may be stored in the recording medium 10i, and the reader 10g may read the program 10h from the recording medium 10i and store the program in the storage 10d.

Examples of the recording medium 10i include a non-transitory computer-readable recording medium such as a magnetic/optical disk or a flash memory. Examples of the magnetic/optical disk include a flexible disk, a compact disc (CD), a digital versatile disc (DVD), a Blu-ray disc, and a holographic versatile disc (HVD). Examples of the flash memory include semiconductor memories such as a USB memory and an SD card.

The above-described HW configuration of the computer 10 is an example. Therefore, an increase or decrease in the number of pieces of HW (for example, addition or deletion of an arbitrary block), division, integration in an arbitrary combination, addition or deletion of a bus, or the like in the computer 10 may be appropriately performed.

### A-2. Functional Configuration Example

As illustrated in FIG. 1, the information processing system 1 may illustratively include functions as the user process 20 and the scheduler 17. These functions may be realized by hardware of the computer 10 (refer to FIG. 2).

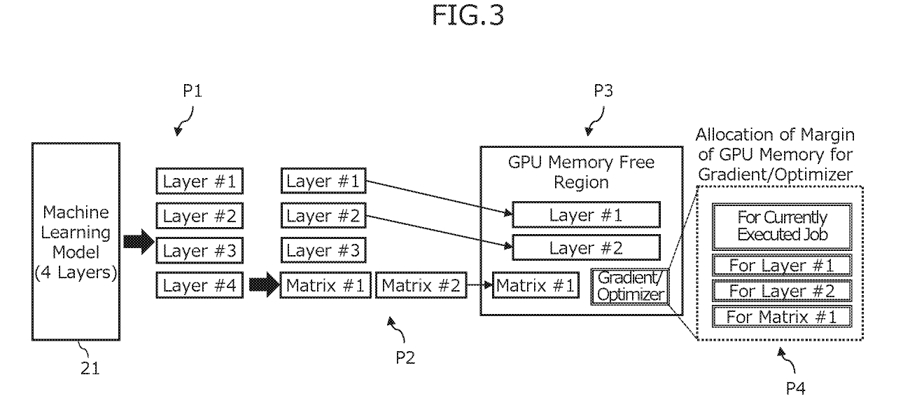

The user process 20 is, for example, a process of performing inference using a machine learning model 21 (refer to FIG. 3), and is executed by the CPU 10a executing a user program. The machine learning model 21 may be a deep learning model.

For example, in a process of an inference phase using the deep learning model, preprocessing for receiving a request and the like, inference processing (main processing), and post-processing are repeatedly executed. Hereinafter, the machine learning model 21 may be simply referred to as a model.

Similarly, in a process of a training phase using the deep learning model, preprocessing, machine learning (main processing), and post-processing are repeatedly executed.

The CPU 10a may execute processing related to allocation of the user program. In the processing, the CPU 10a may allocate preprocessing and post-processing of the user program to itself (the CPU 10a), and allocate the main processing of the user program to the GPU 10b.

The user process 20 outputs an allocation request for switching a computation resource from the CPU 10a to the GPU 10b to a GPU allocator 12 of the scheduler 17 which will be described later, for example, at the time of transition from the preprocessing to the main processing. The allocation request for switching a computation resource from the CPU 10a to the GPU 10b may be referred to as a GPU request.

Furthermore, the user process 20 outputs a notification (GPU release notification) indicating that the used GPU 10b is released to the GPU allocator 12 at the end of the main processing, that is, at the time of transition from the main processing to the post-processing.

Further, the user process 20 notifies a driver 11 of the scheduler 17 of a stop notification at the end of its own processing, for example.

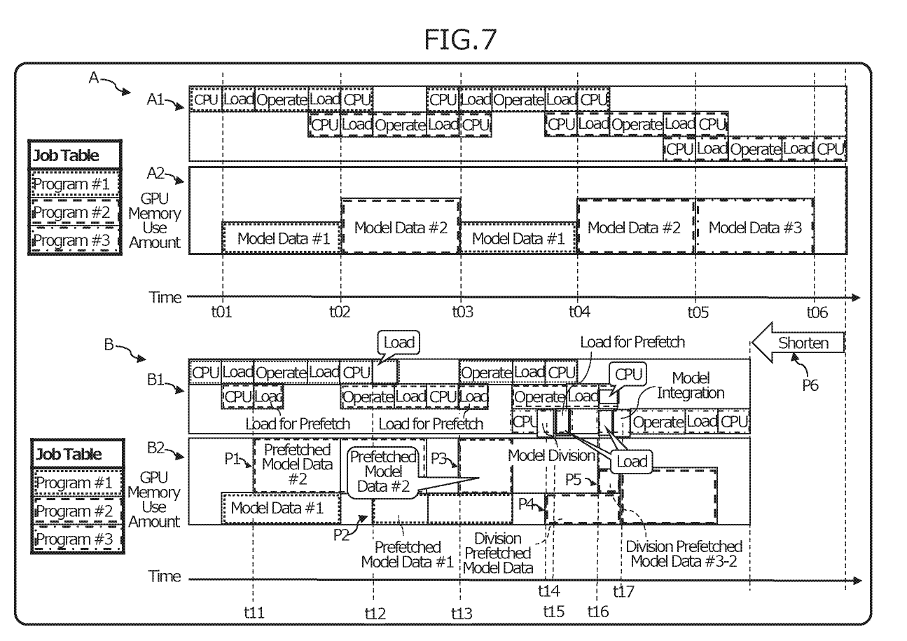

Note that a series of processing including pre-processing, main processing, and post-processing may be referred to as a job. In the present information processing system 1, one user program may execute one user process 20, and a plurality of user processes 20 may be executed by executing a plurality of user programs. Further, one user program may execute a plurality of user processes 20. In the present embodiment, for convenience, an example in which one user program executes one user process 20 will be described. Hereinafter, the user program may be simply referred to as a program. Furthermore, a plurality of programs may be represented using reference symbols #1 to #3 and the like (refer to FIG. 7). In addition, the user process 20 may be simply referred to as a process.

Furthermore, when a processor such as the CPU 10a or the GPU 10b executes a program, moving data that is needed to execute the program to the CPU memory (memory 10c) or the GPU memory may be referred to as loading. In particular, loading of model data may be referred to as model loading. Further, loading data before a computation resource (processor) executes processing may be referred to as prefetch. In particular, performing model loading before the computation resource (processor) executes model processing may be referred to as model prefetch.

The user process 20 also transmits information on a job to be executed to the scheduler 17. The information on the job transmitted by the user process 20 is registered in a job table 13 which will be described later. The information on the job includes information (model information) of the machine learning model 21 used to execute the job.

In the present information processing system 1, the scheduler 17 performs scheduling of allocating computation resources (CPU 10a and GPU 10b) to each of a plurality of programs and causing the programs to execute a job.

In addition, upon completion of processing using the GPU 10b, the user process 20 transmits, to the scheduler 17, a GPU release notification for notifying that the GPU 10b is released.

The scheduler 17 schedules execution of a program using the computation resource (GPU 10b).

As illustrated in FIG. 1, the scheduler 17 has functions as the driver 11, the GPU allocator 12, a job table 13, a division model integration processor 14, a model division processor 15, and a memory size predictor 16.

The driver 11 activates the user process 20. In addition, a stop notification is input to the driver 11 at the end of the user process 20.

The job table 13 manages information related to a job scheduled to be executed. For example, the job table 13 stores, regarding a job, information indicating a program for executing the job, and information on a processing content and a use model of the program in association with each other. The use model is information representing the machine learning model 21 used to execute the job. The information on the use model may include the data amount (model data size) of the machine learning model 21. Note that, in the job table 13, information on the order of execution (execution order) of registered jobs may be managed, and various modifications can be made. By referring to the job table 13, it is possible to ascertain the machine learning model 21 to be processed by the GPU 10b next.

The memory size predictor 16 predicts the capacity (free space, free memory size) of a free region of the GPU memory when the GPU 10b is caused to execute a job registered in the job table 13.

Therefore, the memory size predictor 16 first predicts a consumed memory size (maximum consumed memory size) for each of one or more jobs registered in the job table 13. Hereinafter, a job registered in the job table 13 may be referred to as a prediction target job. Further, the predicted consumed memory size may be referred to as a predicted consumed memory size.

For example, every time a job (program) is executed by the GPU 10b, the memory size predictor 16 may measure the use amount (consumed memory size) of the GPU memory at the time of execution of the job, and record the maximum value (maximum consumed memory size) as execution history information. That is, the execution history information includes information on the maximum consumed memory size of jobs executed in the past.

The memory size predictor 16 may associate information for identifying a job or a program with the maximum consumed memory size in the execution history information and store the information in the storage 10d or the like.

The memory size predictor 16 predicts the consumed memory size of a prediction target job on the basis of the execution history information. For example, the memory size predictor 16 may read the maximum consumed memory size of a job executed by the same program as the prediction target job from the execution history information and determine the read maximum consumed memory size as the predicted consumed memory size of the prediction target job.

Note that a method of determining a predicted consumed memory size by the memory size predictor 16 is not limited thereto, and various modifications can be made. For example, the memory size predictor 16 may determine the predicted consumed memory size by adding a predetermined margin to the maximum consumed memory size of the job executed by the same program as the prediction target job read from the execution history information or multiplying the same by a predetermined coefficient.

Regarding a job (program) for which the consumed memory size is not recorded in the execution history information, the memory size predictor 16 may use, for example, a preset specified value as the predicted consumed memory size of the job.

The memory size predictor 16 predicts the amount of memory in which a job to be executed uses the GPU memory on the basis of the execution history of the job using the machine learning model 21.

Then, the memory size predictor 16 calculates (predicts) a free space (free memory size) of the GPU memory on the basis of the predicted consumed memory size. That is, the memory size predictor 16 predicts the free space of the GPU memory on the basis of the memory amount in which the predicted job to be executed uses the GPU memory.

For example, the memory size predictor 16 calculates the free space of the GPU memory by subtracting the predicted consumed memory size of a job (program) being executed in the GPU 10b from the memory amount of the GPU memory (GPU memory capacity).

The model division processor 15 executes model division processing for dividing the machine learning model 21. For example, the model division processor 15 may divide the machine learning model 21 into layers (units of layers) constituting the machine learning model 21. Furthermore, the model division processor 15 may divide one layer into a plurality of matrices. Note that processing of dividing the machine learning model 21 into layers and processing of dividing one layer into a plurality of matrices can be realized using known methods, and description thereof will be omitted. The model division processing is assumed to include at least one of processing of dividing the machine learning model 21 into layers or processing of dividing one layer into a plurality of matrices. Furthermore, each of the plurality of layers generated by dividing the machine learning model 21 through the model division processor 15 may be referred to as a partial model. Further, model data of the partial model may be referred to as partial model data.

The model division processor 15 may execute model division processing in accordance with an instruction from the GPU allocator 12 which will be described later.

The GPU allocator 12 has a function of performing scheduling for allocating the GPU 10b (computation resource) to the user process 20 (program) that has transmitted the GPU request. Therefore, the GPU allocator 12 has a function of managing an execution state of a program in the GPU 10b.

The GPU allocator 12 may manage the state of job allocation to the GPU 10b using, for example, a resource table (not illustrated). In the resource table, for example, in a case where a job is allocated to the GPU 10b, information for identifying the allocated user process 20 may be associated with information for identifying the GPU 10b. Furthermore, in a case where no job is allocated to the GPU 10b, information indicating that the GPU 10b is in a free state may be stored in association with information for identifying the GPU 10b in the resource table. Further, the GPU allocator 12 also manages information on a job being executed by the GPU 10b.

When a GPU request is input from the user process 20, the GPU allocator 12 refers to the resource table described above and checks whether the GPU 10b can be allocated to the user process 20. In a case where the GPU 10b can be allocated, the GPU allocator 12 allocates the GPU 10b to the user process 20.

Furthermore, the GPU allocator 12 may allocate the GPU 10b to the user process 20 at a timing when the GPU 10b is in an unused state (free state).

In a case where the GPU request is input from a plurality of user processes 20, the GPU allocator 12 may allocate the GPU 10b in order from the user process 20 that has previously input the GPU request.

Upon determining the allocation of the GPU 10b, the GPU allocator 12 responds to the user process 20 with an allocation result notification. Furthermore, the GPU allocator 12 may instruct execution of the process by the GPU 10b by responding to the user process 20 with an allocation result notification at a time determined by scheduling, for example.

The user process 20 that has received the allocation result notification is executed by the GPU 10b. The user process 20 transmits a GPU release notification to the GPU allocator 12 at the end of the processing (main processing).

Note that the method of allocating the GPU 10b to the user process 20 by the GPU allocator 12 described above is an example, and the method is not limited thereto. For example, the GPU allocator 12 may simultaneously allocate the GPU 10b to a plurality of user processes 20, and various modifications can be made.

The GPU allocator 12 determines whether the GPU 10b can be allocated to the user process 20 (program) that has transmitted the GPU request. A processing handling program executed by the user process 20 that has transmitted the GPU request may be referred to as a processing target program.

Hereinafter, the fact that the GPU 10b can be allocated to the processing target program may be expressed as “the GPU 10b can be secured ”.

When the GPU 10b cannot be secured, the GPU allocator 12 causes the CPU 10a to execute the processing target program. Note that, in a case where the GPU 10b cannot be secured, the GPU allocator 12 may cause the execution of the processing target program to stand by until the GPU 10b can be secured.

In addition, the GPU allocator 12 has a function of controlling prefetch (model prefetch) of model data used for processing by a program.

The GPU allocator 12 refers to the job table 13 and identifies a program to be executed next using the GPU 10b and the machine learning model 21 used by the program. Next, the machine learning model 21 used by a program to be executed by the GPU 10b may be referred to as the machine learning model 21 as a prefetch verification target.

The GPU allocator 12 acquires the model size (data amount) of the machine learning model 21 as a prefetch verification target, and determines whether the entire model data of the machine learning model 21 can be loaded into the GPU memory.

The GPU allocator 12 compares the model size of the machine learning model 21 as a prefetch verification target with the free space of the GPU memory. That is, the GPU allocator 12 compares the free space of the GPU memory (memory) included in the GPU 10b (computation resource) with the data amount of the model data of the machine learning model 21.

In a case where the model size of the machine learning model 21 as a prefetch verification target is equal to or smaller than the free space of the GPU memory, the GPU allocator 12 determines that the entire model data can be loaded. That is, the GPU allocator 12 determines that the machine learning model 21 as a prefetch verification target can be stored in the GPU memory.

Here, in a case where the GPU 10b is already executing a program, the GPU allocator 12 reflects the predicted consumed memory size of the program being executed in the free space of the GPU memory.

That is, the GPU allocator 12 uses, as the free space of the GPU memory, the free space of the GPU memory calculated by the memory size predictor 16 subtracting the predicted consumed memory size of the job (program) being executed in the GPU 10b from the GPU memory capacity.

In a case where the machine learning model 21 as a prefetch verification target can be stored in the GPU memory, the GPU allocator 12 requests prefetch of the machine learning model 21 for the user process 20 using the machine learning model 21, and prefetches the entire model data of the machine learning model 21 to the GPU memory. Requesting prefetch of the model data of the machine learning model 21 may be referred to as a model prefetch request.

Furthermore, in a case where the machine learning model 21 as a prefetch verification target cannot be stored in the GPU memory, the GPU allocator 12 causes the model division processor 15 to execute model division processing of the machine learning model 21 as a prefetch verification target, and stores generated partial model data in a free region of the GPU memory. That is, the GPU allocator 12 generates a plurality of pieces of partial model data by dividing the model data of the machine learning model 21 into layers constituting the machine learning model 21, and prefetches a part of partial model data corresponding to the free space of the GPU memory among the plurality of pieces of partial model data.

FIG. 3 is a diagram for describing model division processing for model prefetch in the information processing system 1 according to an embodiment.

FIG. 3 illustrates an example in which the machine learning model 21 having four layers #1 to #4 is divided and part of model data is loaded into the free region of the GPU memory.

The model division processor 15 divides the machine learning model 21 into layers to generate partial models #1 to #4 (refer to reference symbol P1). In FIG. 3, the generated partial models are represented as layers #1 to #4.

Furthermore, the model division processor 15 divides the layer #4 to generate two matrices #1 and #2 (refer to reference symbol P2).

The GPU allocator 12 may select, from among the plurality of generated partial models, a partial model to be processed first in the machine learning model 21 (in order from the upstream side of the processing) and load the partial model into the free region of the GPU memory. FIG. 3 illustrates an example in which the layers #1 and #2 and the matrix #1 are loaded into the free region of the GPU memory (refer to reference symbol P3).

That is, the GPU allocator 12 loads a part of data (partial model data) of a plurality of partial models (layers) generated by dividing the machine learning model 21 to the GPU memory in accordance with the free region thereof.

At this time, the GPU allocator 12 also loads the microbatch into the GPU memory. Although it is not needed at the time of prefetching, it is needed to manage storage areas for a gradient and an optimizer on the GPU memory when a machine learning process (training phase) is started. Therefore, it is desirable to provide a margin (storage area) for storing the gradient and the optimizer corresponding to the partial model data loaded to the GPU memory in the free region of the GPU memory (refer to reference symbol P4).

FIG. 3 illustrates an example in which, as the portions of gradients/optimizers, a margin (storage area) between the portions of the gradient and the optimizer of the machine learning model 21 used by the currently executed job (the portion of the currently executed job), the portions of the gradient and the optimizer of the layers #1 and #2 (portion of Layer #1, portion of Layer #2), and the portions of the gradient and the optimizer of the matrix #1 (portion of the matrix #1) is provided in the free region of the GPU memory.

The division model integration processor 14 combines (integrates) the partial model data generated by dividing the machine learning model 21 by the model division processor 15 and a plurality of matrices generated by dividing one layer to restore the machine learning model 21.

After all the partial model data constituting the model data are loaded into the GPU memory, the division model integration processor 14 may combine the plurality of pieces of partial model data. In addition, the division model integration processor 14 may sequentially combine the partial model data loaded in the GPU memory among the plurality of partial model data constituting the model data, and various modifications can be made.

Note that processing of combining a plurality of layers and processing of combining a plurality of matrices to generate one layer can be realized using known methods, and the description thereof will be omitted.

### B. Operation

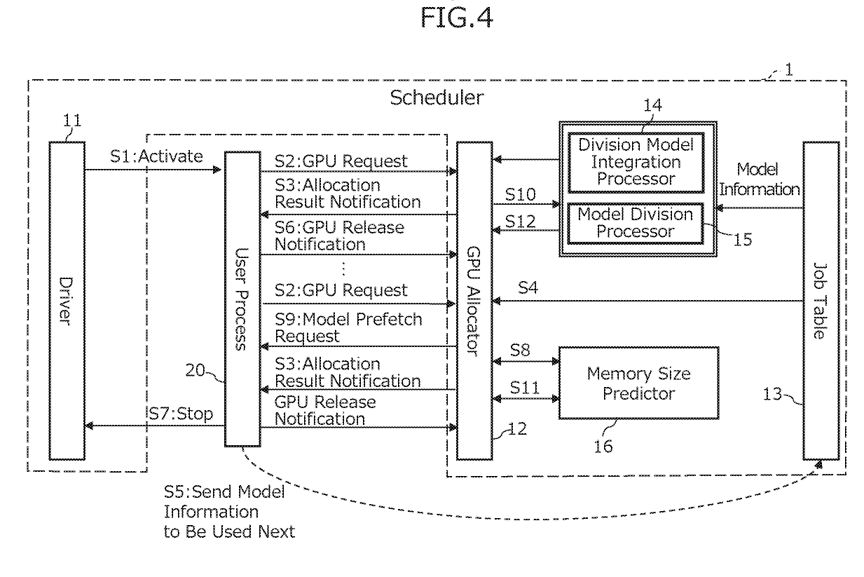

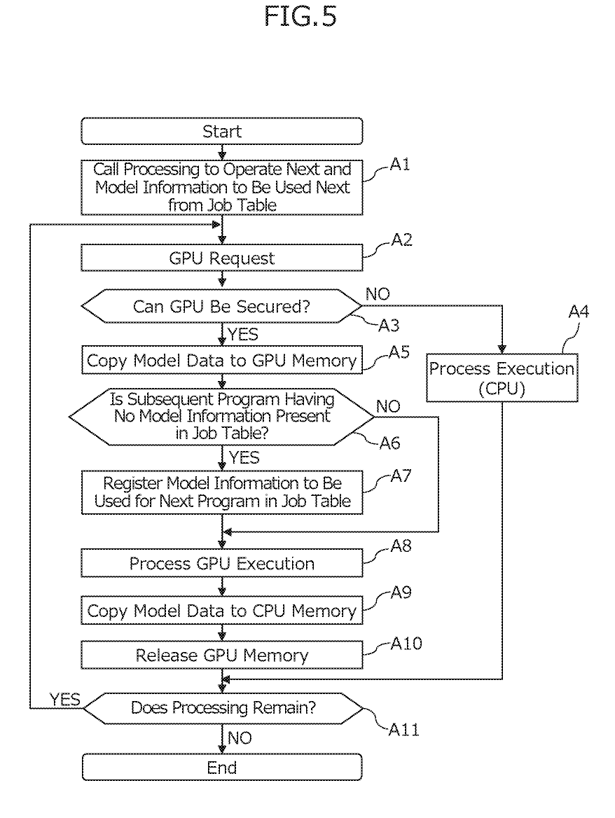

Processing at the time of execution of a job by the user process 20 of the information processing system 1 according to an embodiment configured as described above will be described according to the flowchart (steps A1 to A11) illustrated in FIG. 5 with reference to FIG. 4. FIG. 4 is a diagram illustrating data transfer in the information processing system 1 according to an embodiment.

The present processing is started by executing a user program for realizing the user process 20. The user process 20 is activated by the driver 11 (refer to reference symbol S1 in FIG. 4).

In step A1, the user process 20 calls, from the job table 13, processing to be operated next and information (model information) on the machine learning model 21 used by this processing.

In step A2, the user process 20 transmits a GPU request to the scheduler 17 (GPU allocator 12) (refer to reference symbol S2 in FIG. 4).

In step A3, the user process 20 determines whether the GPU 10b has been secured in the scheduler 17. For example, in a case where an allocation result notification indicating that allocation of the GPU 10b has been successfully performed is responded from the GPU allocator 12 (refer to reference symbol S3 in FIG. 4), the user process 20 determines that the GPU 10b has been secured. In addition, in a case where the allocation result notification indicating that allocation of the GPU 10b cannot be performed is responded from the GPU allocator 12, the user process 20 determines that the GPU 10b has not been secured. Note that the user process 20 may determine that the GPU 10b has not been secured in a case where the allocation result notification indicating that the GPU 10b has been secured is not sent from the GPU allocator 12 within a predetermined time.

In a case where the GPU 10b has not been secured (refer to NO route in step A3), the user process 20 executes processing using the CPU 10a in step A4. Thereafter, the processing proceeds to step A11.

In addition, as a result of the determination in step A3, in a case where the GPU 10b has been secured in the scheduler 17 (refer to YES route in step A3), the processing proceeds to step A5.

In step A5, the user process 20 copies the model data of the machine learning model 21 for use in executing the job to the GPU memory.

In step A6, the user process 20 checks whether there is a program for which model information is not registered in the job table 13 among the programs (subsequent programs) to be executed subsequently (refer to reference symbol S4 in FIG. 4). If there is a subsequent program for which model information is not registered in the job table 13 (refer to YES route in step A6), the processing proceeds to step A7.

In step A7, the user process 20 transmits model information of the machine learning model 21 to be used by the subsequent program to the scheduler 17 (refer to reference symbol S5 in FIG. 4), and causes the model information to be registered in the job table 13. That is, the user process 20 registers the machine learning model 21 to be used in the next process in the job table 13. Thereafter, the processing proceeds to step A8.

If there is no subsequent program for which model information is not registered in the job table 13 (refer to NO route in step A6), step A7 is skipped, and the processing proceeds to step A8.

At step A8, processing of the user process 20 is performed by the allocated GPU 10b.

In step A9, the user process 20 copies the model data of the machine learning model 21 to the CPU memory. As a result, the computation resource for executing the user process 20 becomes (is returned to) the CPU 10a.

At step A10, the user process 20 transmits a GPU release notification to the GPU allocator 12 to release the GPU memory (refer to reference symbol S6 in FIG. 4). In step A11, the user process 20 checks whether any processing in the process thereof remains. If any processing remains (refer to YES route in step A11), the processing returns to step A2. On the other hand, in a case where there is no remaining processing (refer to NO route in step A11), the user program (user process 20) is ended. The driver 11 is notified of stop of the user process 20 (refer to reference symbol S7 in FIG. 4).

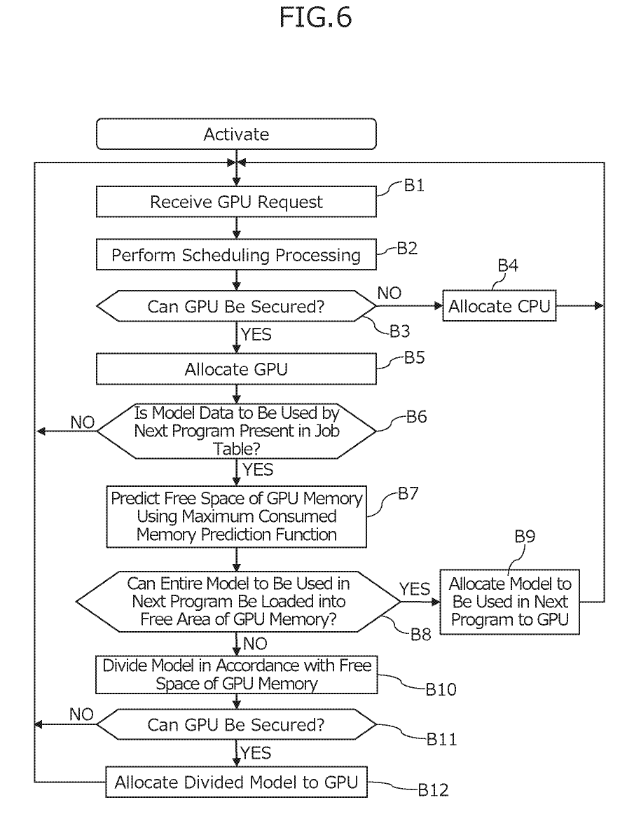

Next, processing of the scheduler 17 of the information processing system 1 according to an embodiment will be described according to the flowchart (steps B1 to B12) illustrated in FIG. 6 with reference to FIG. 4.

In step B1, the scheduler 17 (GPU allocator 12) receives a GPU request from the user process 20 (refer to reference symbol S2 in FIG. 4), thereby performing the following processing.

In step B2, the GPU allocator 12 performs scheduling for causing the GPU 10b to execute a program (processing target program) for which a GPU request has been issued.

In step B3, the GPU allocator 12 checks whether the GPU 10b has been secured for the processing target program. In a case where the GPU 10b has not been secured for the processing target program (refer to NO route in step B3), the processing proceeds to step B4.

In step B4, the GPU allocator 12 allocates the CPU 10a to the processing target program. Thereafter, the processing returns to step B1.

In addition, in a case where the GPU 10b has been secured for the processing target program (refer to YES route in step B3, refer to reference symbol S3 in FIG. 4), the processing proceeds to step B5. In step B5, the GPU allocator 12 allocates the GPU 10b to the processing target program.

In step B6, the GPU allocator 12 checks whether the model data of the machine learning model 21 used by the program to be processed next is registered in the job table 13 (refer to reference symbol S4 in FIG. 4). In a case where the model data of the machine learning model 21 used by the program to be processed next is not registered in the job table 13 (refer to NO route in step B6), the processing returns to step B1.

On the other hand, in a case where the model data of the machine learning model 21 used by the program to be processed next is registered in the job table 13 (refer to YES route in step B6), the processing proceeds to step B7.

In step B7, the memory size predictor 16 predicts the predicted consumed memory size of the job (prediction target job) registered in the job table 13, and calculates (predicts) the free space (free memory size) of the GPU memory on the basis of the predicted consumed memory size.

In step B8, the GPU allocator 12 checks whether the entire model data of the machine learning model 21 used by the program to be processed next, that is, the machine learning model 21 as a prefetch verification target can be loaded into the free region of the GPU memory.

At this time, the GPU allocator 12 checks whether the entire model data can be loaded into the free region of the GPU memory on the basis of the model size of the machine learning model 21 as a prefetch verification target, the GPU memory capacity amount, and the predicted consumed memory size predicted by the memory size predictor 16 (refer to reference symbol S8 in FIG. 4).

If the entire model data of the machine learning model 21 as a prefetch verification target can be loaded into the free region of the GPU memory (refer to YES route in step B8), the processing proceeds to step B9.

In step B9, the GPU allocator 12 allocates the entire model data of the machine learning model 21 used by the program to be processed next, that is, the machine learning model 21 as a prefetch verification target, to the GPU 10b, and loads (prefetches) the entire model data into the GPU memory (refer to reference symbol S9 in FIG. 4). Thereafter, the processing returns to step B1.

On the other hand, in a case where the entire model data of the machine learning model 21 as a prefetch verification target cannot be loaded into the free region of the GPU memory (refer to NO route in step B8), the processing proceeds to step B10.

In step B10, the GPU allocator 12 causes the model division processor 15 to execute model division processing of the machine learning model 21 as a prefetch verification target (refer to reference symbol S10 in FIG. 4). The model division processor 15 divides the machine learning model 21 as a prefetch verification target into a plurality of partial models.

In step B11, the GPU allocator 12 checks whether the GPU 10b has been secured. In a case where the GPU 10b has not been secured (refer to NO route in step B 11), the processing returns to step B1. Furthermore, in a case where the GPU 10b has been secured (refer to YES route in step B 11), the processing proceeds to step B12.

In step B12, the GPU allocator 12 allocates some of a plurality of partial models (layers) generated by dividing the machine learning model 21 to the GPU 10b. At this time, the GPU allocator 12 calculates the amount (number) of partial model data that can be loaded (prefetched) into the free region of the GPU memory among a plurality of partial models (layers) generated by dividing the machine learning model 21 (refer to reference symbol S11 in FIG. 4).

As a result, some of the plurality of partial models (layers) generated by dividing the machine learning model 21 are loaded into the GPU memory in accordance with the free region (refer to reference symbol S12 in FIG. 4). Thereafter, the processing returns to step B1.

### C. Effects

FIG. 7 is a diagram illustrating a method of loading model data in the information processing system 1 according to the embodiment in comparison with a conventional method.

In FIG. 7, a reference symbol A indicates a conventional model data loading method, and a reference symbol B indicates a model data loading method by the present information processing system 1. In addition, reference symbols A1 and B1 indicate a flow of processing of a plurality of (three in the example illustrated in FIG. 7) programs #1 to #3, and reference symbols A2 and B2 indicate a storage state of model data in the GPU memory. In addition, a rightward arrow in the drawing indicates a lapse of time.

In any of the methods denoted by reference symbols A and B, the program #1 uses model data #1, the program #2 uses model data #2, and the program #3 uses model data #3.

In the conventional model data loading method, as indicated by reference symbol A, the model data is loaded into the GPU memory at timing when the program executes processing using the model data (refer to times t01 to t05). The programs #1 to #3 all release the GPU memory at the timing when processing using the model data by the GPU ends (refer to times t02 to t06).

On the other hand, in the method of loading model data in the present information processing system 1, if there is a free space in the GPU memory, the entire model data or a part of the model data (partial model data) of the machine learning model 21 used by a program that is not being executed is prefetched.

In the example illustrated in FIG. 7, as indicated by reference symbol B, the entire model data #1 is prefetched (loaded for prefetch) at time t12 (refer to reference symbol P2). The entire model data #2 is prefetched at times t11 and t13 (refer to reference symbols P1 and P3). Further, the model data #3 is divided into two pieces of partial model data #3-1 and #3-2 at time t14, the partial model data #3-1 is prefetched at time t15 (refer to reference symbol P4), and the partial model data #3-2 is prefetched at time t16 (refer to reference symbol P5).

Then, the division model integration processor 14 combines (integrates) the partial model data #3-1 and #3-2 loaded into the GPU memory at time t17.

As described above, in the method of loading model data in the information processing system 1, if there is a free space in the GPU memory, the entire model data or a part of the model data (partial model data) of the machine learning model 21 used by a program that is not being executed is prefetched. As a result, a plurality of model loads are executed in parallel, the time that is needed for model loading can be shortened, and the time that is needed for processing a plurality of (three in the example illustrated in FIG. 7) programs #1 to #3 can be shortened as compared with the conventional method (refer to reference symbol P6).

As described above, according to the information processing system 1 as an example of an embodiment, the GPU allocator 12 prefetches the model data of the machine learning model 21, and thus the time that is needed for model loading can be shortened, and the time that is needed for processing a plurality of programs can be shortened.

In a case where the entire model data can be loaded into the free region of the GPU memory, by prefetching the entire model data used by the program subsequent to the program being executed, the time that is needed for processing of the plurality of programs can be significantly shortened.

Even in a case where the entire model data cannot be loaded into the free region of the GPU memory, it is possible to shorten the time that is needed to process the plurality of programs by prefetching a part of the model data (partial model data) used by the program subsequent to the program being executed. In addition, the GPU memory can be efficiently used.

### D. Others

The disclosed technology is not limited to the above-described embodiment, and various modifications can be made without departing from the gist of the present embodiment.

For example, in the above-described embodiment, an example in which the computer 10 includes one CPU 10a has been described, but the present embodiment is not limited thereto, and the computer 10 may include two or more CPUs 10a. Similarly, in the above-described embodiment, an example in which the computer 10 includes one GPU 10b is illustrated, but the present embodiment is not limited thereto, and the computer 10 may include two or more GPUs 10b.

Furthermore, in the above-described embodiment, the example of the GPU 10b has been described as an example of a computation resource, and the example of the GPU memory has been described as an example of a memory, but the present embodiment is not limited thereto, and can be appropriately modified and implemented.

Furthermore, in the example illustrated in FIG. 7, the model data #3 is prefetched twice, but the present embodiment is not limited thereto. The model data may be prefetched three or more times, and various modifications can be made.

Furthermore, according to the disclosure described above, the present embodiment can be carried out and manufactured by those skilled in the art.

According to an embodiment, a processing time of a plurality of processes using a machine learning model can be reduced.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer having a computation resource to execute a process comprising:
comparing a free space of a memory included in the computation resource with a data amount of model data of a machine learning model;
prefetching the entire model data into the memory when the data amount is equal to or less than the free space; and
when the data amount is greater than the free space, generating a plurality of pieces of partial model data by dividing the model data in units of layers constituting the machine learning model, and prefetching one or more pieces of the plurality of partial model data corresponding to the free space among the plurality of pieces of partial model data.

2. The non-transitory computer-readable recording medium having stored therein an information processing program according to claim 1, wherein the computer is caused to execute a process comprising:
predicting a memory amount in which a job to be executed uses the memory on the basis of an execution history of a job using the machine learning model; and
predicting the free space of the memory on the basis of the predicted memory amount.

3. An information processing apparatus comprising:
a memory;
a processor connected to the memory; and
a computation resource,
wherein the processor is configured to:
compare a free space of a memory included in the computation resource with a data amount of model data of a machine learning model;
prefetch the entire model data into the memory when the data amount is equal to or less than the free space; and
when the data amount is greater than the free space, generate a plurality of pieces of partial model data by dividing the model data in units of layers constituting the machine learning model, and prefetch one or more pieces of the plurality of partial model data corresponding to the free space among the plurality of pieces of partial model data.

4. The information processing apparatus according to claim 3, wherein the processor executes a process comprising:
predicting a memory amount in which a job to be executed uses the memory on the basis of an execution history of a job using the machine learning model; and
predicting the free space of the memory on the basis of the predicted memory amount.

5. An information processing method, using a computer having a computation resource, comprising:
comparing a free space of a memory included in the computation resource with a data amount of model data of a machine learning model;
prefetching the entire model data into the memory when the data amount is equal to or less than the free space; and
when the data amount is greater than the free space, generating a plurality of pieces of partial model data by dividing the model data in units of layers constituting the machine learning model, and prefetching one or more pieces of the plurality of partial model data corresponding to the free space among the plurality of pieces of partial model data.

6. The information processing method according to claim 5, comprising:
predicting a memory amount in which a job to be executed uses the memory on the basis of an execution history of a job using the machine learning model; and
predicting the free space of the memory on the basis of the predicted memory amount.
